(19) United States
(12) Patent Application Publication
(10) Pub. No.: US 2012/0211029 A1
(43) Pub. Date: Aug. 23, 2012

(54) LOAD LOCK ASSEMBLY AND METHOD FOR PARTICLE REDUCTION

(76) Inventors: Viraj S. Pandit, Milpitas, CA (US); Emery Y. Kuo, Sunnyvale, CA (US)

(21) Appl. No.: 13/369,618

(22) Filed: Feb. 9, 2012

Related U.S. Application Data
(60) Provisional application No. 61/445,282, filed on Feb. 22, 2011.

(51) Int. Cl. B08B 5/00

(52) U.S. Cl. 134/21; 134/56 R; 134/94.1

(57) ABSTRACT

A wafer is substantially discharged in a load lock upon removal from a processing system and prior to storing in a storage compartment. The discharge helps to separate some electrostatically charge particles from the wafers. The particles may be also by creating turbulence inside the load lock during venting and/or purging cycles. These particle removal operations can be performed without significant impact to the overall process throughput.

### CROSS-REFERENCE TO RELATED APPLICATIONS

This application claims the benefit under 35 U.S.C. §119(e) of U.S. Provisional Patent Application 61/445,282, entitled “LOAD LOCK ASSEMBLY AND METHOD FOR PARTICLE REDUCTION” filed on Feb. 22, 2011 (Attorney Docket No. NOVLP290P2US/NVLS003465P2), which is incorporated herein by reference in its entirety.

### FIELD OF THE INVENTION

The present invention generally relates to methods and apparatuses for transferring wafers using a load lock and, more particularly, to methods and apparatuses for cleaning substrate wafers while transferring the substrate wafers from a lower pressure environment to a higher pressure environment, such as transferring the substrate wafers from a process module to a storage module.

### BACKGROUND

Many semiconductor processing operations are performed at very low pressures. Typically, processing modules used in such operations are continuously kept at low pressure while wafers are passed in and out of the modules using various transfer systems, such as a load lock. This approach effectively isolates two pressure environments, such as a low pressure environment inside the processing system from an atmospheric pressure environment outside of the system. This approach eliminates constant and burdensome needs to continuously vacuum the processing modules after processing each wafer or a set of wafers. Moreover, one or more processing systems may be arranged together with corresponding handling and other types of systems within a shared low pressure environment of the overall system, and wafers may be subjected to several different operations inside this low pressure environment before being removed from this environment.

Wafer processing can generate many small particles that get electrostatically and/or gravitationally attached to wafers. Because wafers typically include semiconductor and dielectric materials, they tend to accumulate and retain electrical charge. Particles may be attached to both the front and back sides of the wafer. The presence of such particles can be detrimental and destructive to the wafers. For example, particles may form unintended and highly undesirable shorts within formed integrated circuits on the front side of the wafer. More generally, particles interfere with subsequent wafer processing. Particles attached to the back side may fall onto another wafer positioned underneath during processing or handling and later cause the problems listed above. For example, wafers are typically stored in cassette-like units, such as Front Opening Unified Pods (FOUPs), where one wafer is positioned directly above another. The particle contaminating the bottom side of one wafer can fall on the front surface of the wafer below. Usually wafers are only supported around the edges, which leaves the front side of one wafer directly exposed to the bottom of the wafer above it.

Wafers typically become electrostatically charged during processing, in particular from contacting plasma during Physical Vapor Deposition (PVD) processes. Some charge remains even when wafers are removed from the processing chamber and placed in a FOUP. As a result, many small particles are electrostatically retained on the back sides of the wafers and directly above the front sides of the wafers below. As wafers get discharged during their storage in the FOUP, the particles may fall onto the wafers below. This process is sometimes referred to as “showering.”

### SUMMARY

Provided are wafer cleaning methods and associated apparatuses to remove particles from the wafers while transferring the wafers from one pressure environment to another pressure environment, such as transferring from a low pressure environment of a process module to an atmospheric environment of a storage module. Such transfer and/or particle removal may be performed using a load lock or some other transfer system. Cleaning is achieved by discharging electrostatically charged wafers and/or by providing additional turbulence of the gases in the load lock the transfer. The transfer may involve venting and/or purging cycles. Wafer discharge may involve positioning a wafer on a set of conductive support cones provided in the load lock. An ionized gas may then be introduced into the load lock. Additional pumping and venting sub-cycles may be used during the venting cycle to increase residence time in the load lock, provide additional turbulence, and/or further discharge of the wafer. In certain embodiments, combining wafer discharge with venting and purging cycles during wafer removal does not employ a separate step beyond what is used in conventional load lock processing. Therefore, the process throughput is not substantially impacted. Moreover, turbulence created in the load lock during proposed venting and pressurizing cycles provides additional help with removing particulates from the wafer surfaces.

The cleaning method may start with providing a wafer into a load lock. In the load lock, the wafer may be positioned on a set of conductive support cones that helps to drain at least some charge from the wafer. After the wafer is positioned in the load lock, the load lock is closed and an ionized gas is supplied over the surfaces of the wafer to further discharge the wafer. The ionized gas may be provided during venting and purging cycles, which, as mentioned, may help to dislodge particles from the surface of the wafer due to turbulence created by the gas in addition to discharging the wafer. For example, air or nitrogen could be supplied through an ionizer and into the load lock. The ionized gas may be distributed through a shower head to provide an even flow of the ionized gas over one or both surfaces of the wafer.

In one specific embodiment, the cleaning method involves providing the wafer into the load lock, closing the transfer port of the load lock, and venting the load lock with venting gas to increase the pressure inside the load lock to a first pressure level. Ionized and/or venting gases may be supplied into the load lock after that. One or both types of gases may be supplied into the load lock until the pressure inside the load lock reaches a second pressure level. The second pressure level may correspond to a pressure of the environment at the other transfer port of the load lock. In certain embodiments, the second pressure level is below or equal to the ambient pressure of the storage module. The venting gas may be helium, while the ionized gas may include ions of nitrogen, air, and other like gases. The cleaning method may also involve opening an atmospheric port and supplying the ionized and purging gases into the load lock. One example of the purging gas is argon. The ratio of venting and ionized gas flow rates may be between about 0.1 and 10. In the same or other embodiments, the ratio of purging and ionized gases flow rates is between about 0.1 and 10.

The load lock may include a shower head or other types of delivery ports that provide substantially uniform distribution of ionized gas over the front surface and/or back surface of the wafer. In certain embodiments, the same delivery port distributes the ionized gas over both surfaces. In other embodiments, two delivery ports are used, and each one of these delivery ports delivers the ionized gas to one designated surface of the wafer. The shower heads or delivery ports may also be used to create turbulence around the wafer surfaces to further assist with removing particles. Other gases, such as venting gases and purging gases, may be also supplied through the shower heads or delivery ports.

The method may also involve removing the wafer from the load lock. In some embodiments, the wafer has a total absolute charge of less than about 1 nano-Coulomb at the time of removal. The remaining wafer charge can be either positive or negative. Also, as mentioned, the wafer may be positioned on a set of conductive support cones in the load lock. In a specific embodiment, the conductive support cones include electrostatic discharge ceramic.

In one embodiment, the load lock is vented to the first pressure level, which may be between about 0.01 Torr and 760 Torr. In a specific embodiment, the first pressure level is between about 1 Torr to 50 Torr. Alternatively, the first pressure level may be between about 100 Torr to 700 Torr. The ionized gas is then introduced into the load lock together with the venting gas, and the load lock continues to be vented. In an alternative embodiment, the load lock may be further vented with ionized gas alone. The load lock may then be pumped to the second pressure level, which in one embodiment may be between about 0.01 Torr to 760 Torr. In a specific embodiment, the second pressure level is between about 1 Torr to 50 Torr. Alternatively, the second pressure level may be between about 100 Torr to 700 Torr.

Upon reaching the first pressure level, the load lock may be kept at this level for between about 1 to 10 seconds. Likewise, the load lock may be kept at the second pressure level for between about 1 to 10 seconds. In certain embodiments, the load lock may be purged with the ionized and purging gases for between about 1 to 10 seconds. In alternative embodiments, the load lock may be purged only with the purging gas or only with the ionized gas.

In one embodiment, a load lock system may include a load lock adapted for integration with a processing chamber via a transfer port. The load lock system may also include conductive substrate support cones, a vacuum line, a pressurized gas line, a purge gas line, and an ionizer system configured to deliver ions through an ionizer line to the substrate wafer positioned inside the load lock. The ionizer line may include a non-conductive material that comes in contact with the ions delivered to the substrate wafer. For example, polymer tubing may be used for an ionizer line. The load lock system may also include a controller including program instructions to perform various operations listed above. For example, program instructions may control operations, such as providing the substrate wafer into the load lock, closing the transfer port, and increasing pressure inside the load lock to a first pressure level by supplying a pressurizing gas into the load lock. The program instructions may also control operations, such as supplying an ionized gas and the pressurized gas into the load lock while a pressure inside the load lock is below an ambient pressure of the storage module.

### BRIEF DESCRIPTION OF THE DRAWINGS

FIG. 1 is a schematic illustration of the overall semiconductor processing system including load locks, processing modules, internal and external wafer handling modules, and wafer carriers, in accordance with certain embodiments.

FIG. 2 is a perspective view of the load lock including transfer ports, gas lines, and line connectors, in accordance with certain embodiments.

FIG. 3A is a schematic top view of the wafer positioned on the support cones of the cooling plate inside the load lock, in accordance with certain embodiments.

FIG. 3B is a schematic side view of the wafer positioned on the support cones of the cooling plate inside the load lock, in accordance with certain embodiments.

FIG. 4 is a diagram of the load lock system including the gas lines and the shower head illustrating ionized gas flow around the wafer surface, in accordance with certain embodiments.

FIG. 5 is a flowchart of wafer processing and handling operations performed within a processing system having a load lock, in accordance with certain embodiments.

FIG. 6 is a flowchart of the wafer cleaning method during removal of the wafer from the processing system, in accordance with certain embodiments.

FIGS. 7A-C illustrate plots of pressure inside the load lock as a function of time for different embodiments of performing venting and purging cycles.

FIG. 8 is a plot of the total wafer charge after removal of the wafer from the processing system through a load lock performed at different processing conditions.

### DETAILED DESCRIPTION OF EXAMPLE EMBODIMENTS

### Introduction

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

For purposes of this document, the term “low pressure” typically refers to the pressure on one side of the processing system that is lower than the pressure on the other side of the same system. For example, a pressure inside the processing module may be referred to as a low pressure, and is typically lower in value than the ambient pressure outside the processing module. The term “atmospheric pressure” is defined as a pressure on the outside of the processing module, such as an ambient pressure. Generally, pressure values on the outside are higher than pressure values on the inside of the module. In certain embodiments, values of the “atmospheric pressure” do not represent the ambient pressure and may be some intermediate pressure used in some intermediate chambers. The “pumping” and “vacuuming” terms refer to a reduction of the pressure inside the load lock. The “venting” term corresponds to increasing the pressure inside the load lock, which may be achieved by supplying one or more of the gases. The term “backbone” generally refers to one or more robots and robot arms for moving wafers between processing chambers or between chambers and load locks on the low pressure side of a processing system.

In general, load locks may be used to transfer wafers between two different pressure levels. However, any wafer transfers from a lower pressure environment to a higher pressure environment are within the scope, regardless whether the higher pressure environment corresponds to the ambient pressure or not. For example, a load lock and the cleaning method may be used to transfer a wafer from a deposition chamber maintained at ultra-low pressure levels, such as about 1-1000 nanoTorr, to a backbone area maintained at lower pressure levels relative to the atmospheric pressure but at higher levels than that in the deposition chamber. In certain embodiments, the backbone area is maintained at pressure levels of about 0.01 to 0.5 mTorr. Such transfers may be performed using apparatuses other than load locks and may be generally referred to as transfer systems. In certain embodiments, multiple load locks and/or other types of transfer systems may be used in one processing system. For example, one transfer system may be used for transferring between the atmospheric side and the low pressure side, while another transfer system may be used for transferring between different pressure levels within the low pressure side.

### Apparatus Examples

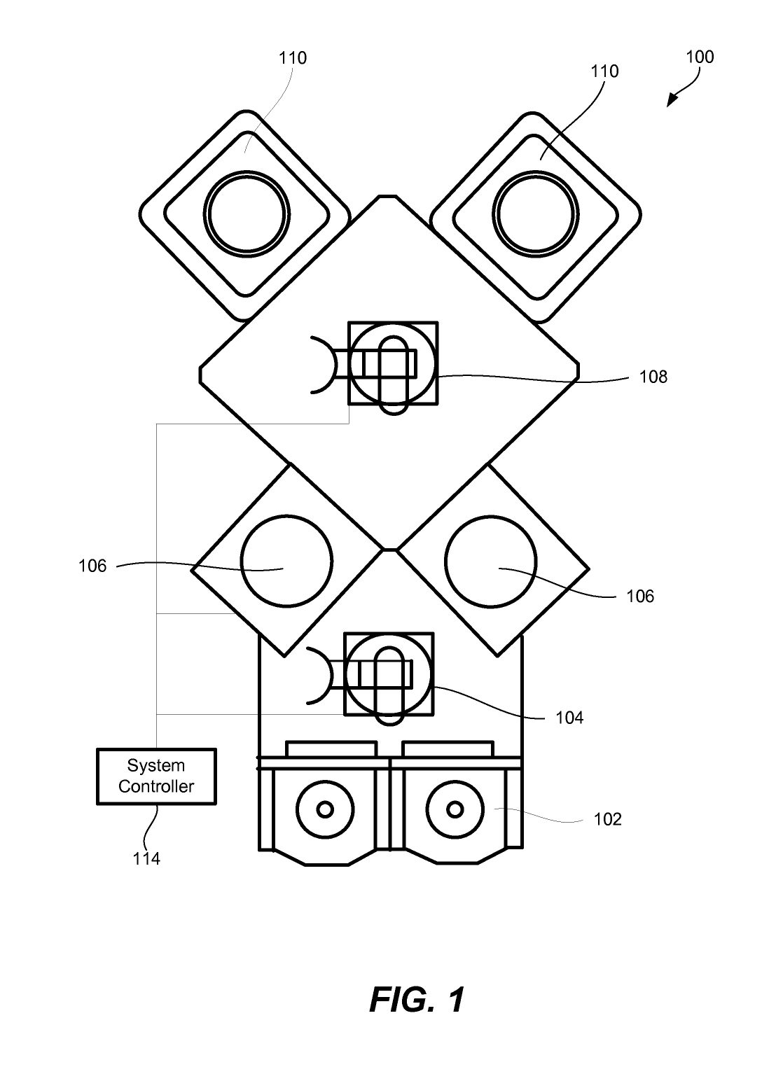

FIG. 1 shows a semiconductor processing system 100, in accordance with certain embodiments. The wafers may be supplied in wafer-storing modules 102, such as FOUPs. An external wafer handling system 104 may include a robot arm and be used to remove wafers from the wafer-storing modules 102 and to load them into one or both load locks 106 through their atmospheric ports. The wafer-storing modules 102, wafer handling system 104, and other associated components are provided on the atmospheric pressure side of semiconductor processing system 100. The semiconductor processing system 100 is shown having two load locks 106. However, any number of load locks may be used in the system. The external wafer handling system 104 may be also used to remove processed wafers from one or both load locks 106 through their atmospheric ports and to position these processed wafers into the wafer-storing modules 102.

The semiconductor processing system 100 is based on an isolation principle, where one part of the system operates at one pressure level, while another part operates at a different pressure level. One side of the system may be referred to a low pressure side, while the other may be referred to as a high pressure side. Since processing is often performed at pressure levels that are lower than the atmospheric pressure, the low pressure side often corresponds to the processing environment, while the high pressure side corresponds to an atmospheric environment and may be also referred to as an atmosphere side. In a typical embodiment, the low pressure side may operate at between about 10⁻⁹ Torr (1 nanoTorr) to 5×10⁻⁴ Torr (0.5 mTorr). The pressure of the low pressure side may vary depending on the processing requirements. For example, wafers may be removed from the load lock at about 0.5 mTorr and transferred to one of the processing modules.

The low pressure side may include a variety of processing modules 110 and internal wafer handling modules 108. Some examples of the processing modules 110 include Physical Vapor Deposition (PVD) chambers, Chemical Vapor Deposition (CVD) chambers, Atomic Layer Deposition (ALD) chambers, degas modules, pre-clean modules, reactive pre-clean (RPC) modules, cooling modules. Other types of modules on the low pressure side may include additional load-locks or transfer systems and backbone systems. While an illustrative example of FIG. 1 only includes two processing modules 110 and one internal wafer handling module 108, it can be readily understood that the processing system 100 may have any number and combinations of such modules. The internal wafer handling module 108, which may also be referred to as a backbone, is used to transfer wafers among various processing modules 110 and the load locks 106. The atmospheric side of the processing system 100 may include wafer storing modules 102, external wafer handling modules 104, and other modules and equipment components.

Other semiconductor wafer processing systems are also within the scope. For example, one or more multi-station reactors may be coupled to a transfer chamber that is coupled to one or more load locks. Suitable semiconductor processing tools, for example, include the modified Novellus Sequel, Inova, Altus, Speed, and Vector systems, produced by Novellus Systems of San Jose, Calif. The reactors need not be multi-station reactors, but may be single station reactors. Similarly, the load locks may be multiple wafer load locks fitted with multiple ionizers (for example, dual wafer load locks fitted with ionizers).

The load locks 106 may be a part of either the low pressure side or the atmospheric side, depending on the state of the wafer transfer. The load locks 106 effectively provide the sole interfaces between these two sides in the entire semiconductor processing system 100. For example, when an atmospheric port of the load lock 106 is open and the transfer port is closed, the load lock 106 is at the atmosphere pressure. In some cases, this state occurs during the purging cycle and during loading/unloading of the wafer using the external wafer handling system 104. Alternatively, when the transfer port is open and the atmospheric port is closed, the load lock 106 is in communication with the low pressure side. For example, this state occurs during loading/unloading of the wafer by the internal wafer handling module 108. Finally, both ports may be closed and the load lock 106 may be going through a venting or pumping cycle. The pressure inside the load lock during these cycles may be between the low pressure level of the low pressure side and the high pressure level of the atmospheric side during a transition phase represented by these cycles. However, in certain embodiments, the pressure inside the load lock during this transition phase may be substantially the same or even lower than the low pressure level of the low pressure side at least for some period of time. In the same or other embodiments, the pressure inside the load lock during this transition phase may be substantially the same or higher than the high pressure level of the high pressure side (e.g., the atmospheric side) at least for some period of time

The semiconductor processing system 100 may include a system controller 114 for receiving feedback signals from various modules of the system 100 and supplying control signals to the same or other modules. The system controller 114 may control operation of the load locks 106, such as timing of the cycles, pressure levels, timing of introducing and flow rates of gases, pumping, and many other process variables. In certain embodiments, the system controller 114 may synchronize the operation of the load locks 106 with respect to other modules, such as the external wafer handling module 104 and the internal wafer handling module 108. In more specific embodiments, the system controller 114 may control operation of valves and flow meters of the gas lines and/or the vacuum lines of the load locks 106. It may also control operations of an ionizer and/or opening and closing of wafer transfer and atmospheric ports. The system controller 114 may be part of an overall system-wide controller that is responsible for operations of the various processing modules, such as operations of a backbone module.

In the depicted embodiment, the system controller 114 is employed to control process conditions during various operations further described below. Some examples of such operations include providing the substrate wafer to the load lock, closing the transfer port of the load lock, venting the load lock by increasing pressure inside the load lock to the first pressure level with a pressurizing gas and then adding the ionized gas, pumping the load lock, opening the atmospheric port, and removing the wafer.

The system controller 114 will typically include one or more memory devices and one or more processors. The processor may include a central processing unit (CPU) or computer, analog and/or digital input/output connections, stepper motor controller boards, and other like components. Instructions for implementing appropriate control operations are executed on the processor. These instructions may be stored on the memory devices associated with the controller or they may be provided over a network.

In certain embodiments, the system controller 114 controls all or most activities of the semiconductor processing system 100. For example, the system controller 114 may control all or most activities of the semiconductor processing system 100 associated with transferring substrates out of the system 100 through one or both load locks 106. The system controller 114 executes system control software including sets of instructions for controlling the timing of the processing steps, pressure levels, gas flow rates, and other parameters of particular operations further described below. Other computer programs, scripts, or routines stored on memory devices associated with the controller may be employed in some embodiments.

Typically, there is a user interface associated with the system controller 114. The user interface may include a display screen, graphical software to display process conditions, and user input devices such as pointing devices, keyboards, touch screens, microphones, and other like components.

The computer program code for controlling the above operations can be written in any conventional computer readable programming language: for example, assembly language, C, C++, Pascal, Fortran or others. Compiled object code or script is executed by the processor to perform the tasks identified in the program.

Signals for monitoring the process may be provided by analog and/or digital input connections of the system controller 114. The signals for controlling the process are output on the analog and digital output connections of the processing system.

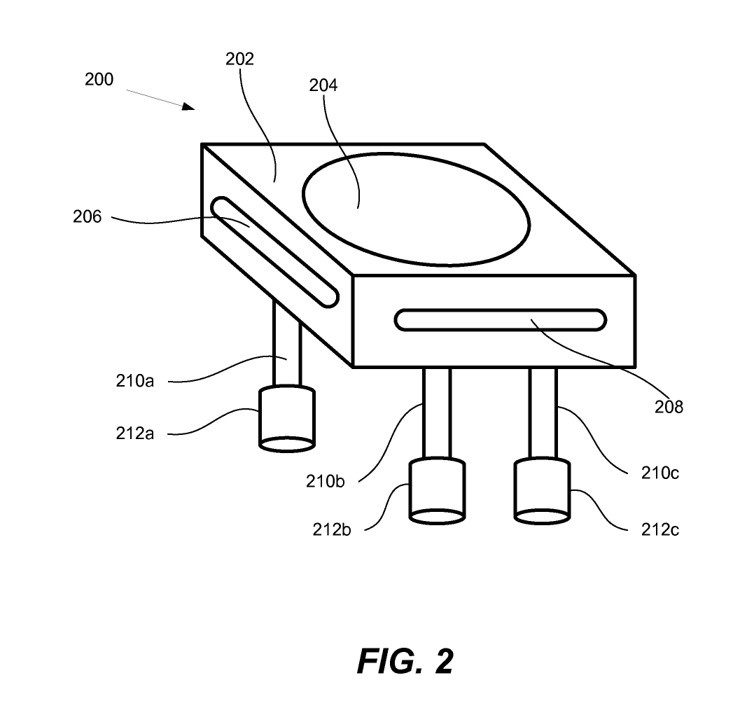

Any types of load locks 106 may be used. For example, partitioned/cycle load locks that allow simultaneous handling of both incoming and outgoing wafers may be used. FIG. 2 shows a simplified perspective view of one example of load lock 200. The load lock 200 includes a body or chamber 202, which may be taken apart for installation and servicing of load lock 200. For example, the chamber 202 may include a removable lid and/or a removable bottom, access ports, and/or other access features. The load lock 200 may include a viewing window 204 for inspecting for a wafer's presence (and condition, if needed) inside the load lock 200. The load lock 200 typically has two ports for transferring wafers into and out of the load lock 200. These ports may be referred to as a transfer port 208 and an atmospheric port 206. The transfer port 208 opens to the low pressure side, such as an internal wafer handling system that moves wafers among the processing modules. The atmospheric port 206 opens to the atmospheric side, such as an external wafer handling system. The load lock 200 also includes a plurality of inlet and outlet lines 210a-c that provide ionized, venting, purging, and other types of gases and allow for the removal of gases during the pumping cycle (i.e., a vacuum pump line). Any number of lines may be connected to the load lock. Moreover, each of the lines 210a-c may have multiple functions. For example, the same line may be used for delivering various gases and vacuuming the load lock. Other piping configurations may be used as well. The lines 210a-c may be fitted with the ports 212a-c including fittings, inserts, machined surfaces, and the like for connecting the load lock lines 210a-c with external lines, such as facility lines and lines of other equipment and processing system modules. The ports 212a-c provide leak free connections between the lines and components attached to these lines (which may be other lines). Moreover, the ports 212a-c may be attached directly to the load lock's chamber 202 without any intermediate lines. For example, such connections may include holes through the load lock chamber with threads, bolt holes, attached flanges, and other like components. Note that FIG. 2 shows only one configuration of the load lock. Other types of load locks may be used as well.

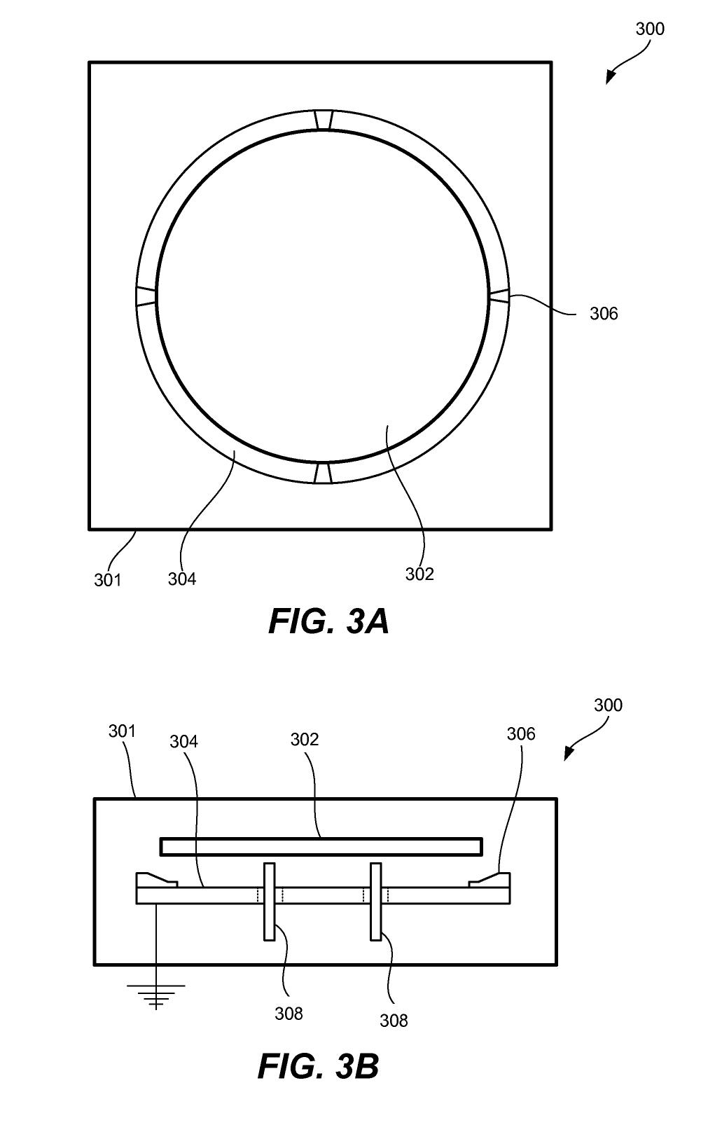

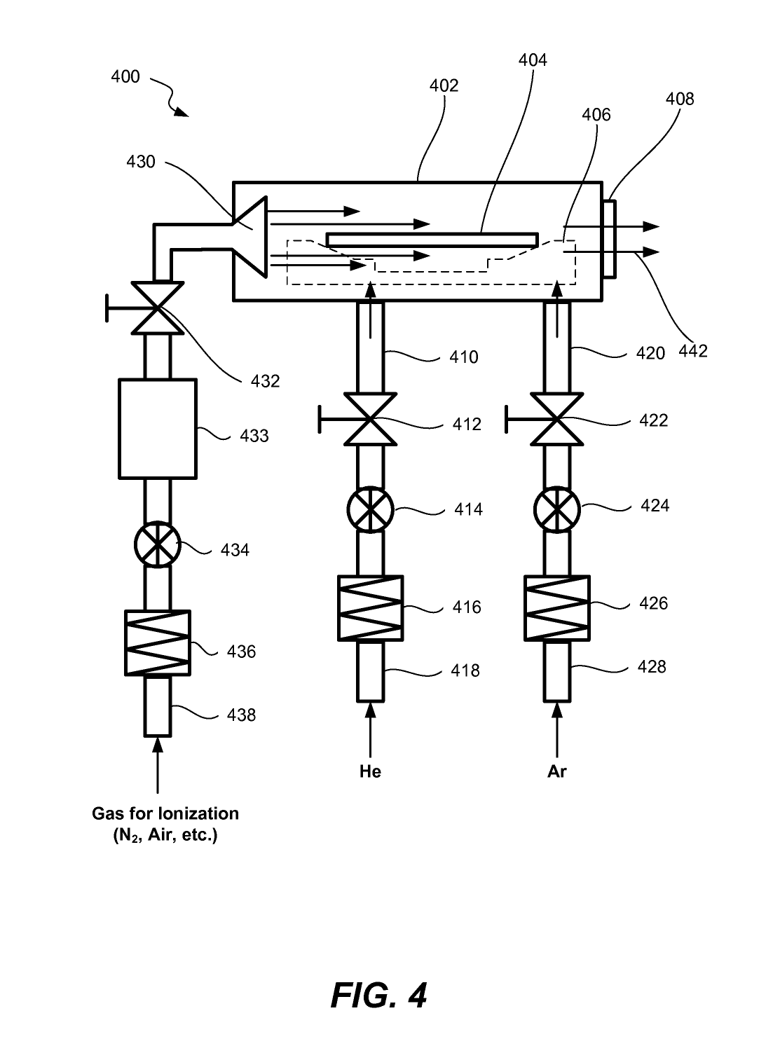

FIGS. 3A and 3B illustrate several internal elements of a typical load lock 300, in accordance with certain embodiments. The load lock includes a cooling plate 304 that supports a set of support cones 306. The cooling plate 304 is typically made of stainless steel, aluminum, or other thermally and electrically conductive materials. The support cones 306 are attached to the cooling plate 304 to ensure electrical conductivity between the two. The number of the support cones 306 may vary depending on the size of the wafer 302 and other process and equipment requirements. For example, a load lock used to transfer a single 300-mm wafer may have five or six supporting cones. The support cones 306 may include conductive material to drain electrostatic charge from the wafer 302. For example, the support cones 306 may include conductive ceramics, such as Cerastat available from XT Xing Technologies GZ Co Ltd in Guangzhou City, China and having volume resistivity between 10³ to 10¹² Ohm-cm.

The conductive support cones 306 may be grounded through the cooling plate 304 to the body 301 of the load lock 300. The wafer 302 establishes electrical contact with the support cones 306 and drains some of the charge. Wafers are made predominantly out of semiconductor material and, therefore, a larger contact surface and more contact points may be desirable for faster discharge. However, larger contact surfaces and more points may increase the risk of damaging wafer surfaces and may present difficulties in aligning the wafer.

The shape, position, and size of the support cones 306 may be set to facilitate alignment of the wafer 302 and to position it closely to the cooling plate 304. The shape of the support cones 306 may determine the contact area with the wafer 302. For example, a larger contact area may be more beneficial for faster discharge of the wafer 302. In some embodiments, the size of the support cones 306 does not allow the robot arm to reach between the wafer 302 and the cooling plate 304. Therefore, a mechanism that temporary supports the wafer 302 in an elevated position may be required. In one embodiment, such mechanism includes a set of lift pins 308 that move up and down with respect to holes in the cooling plate 304. The lift pins 308 are typically made out of stainless steel and have 1 to 4 mm length. In certain embodiments, 6 to 10 lift pins are used. The robot arm supports the wafer 302 from the bottom and brings it into the load lock 300. Then, the robot arm lowers the wafer 302 onto the lift pins 308 and retracts out of the load lock 300. Alternatively, the lift pins 308 may extend up and lift the wafer 302 from the robot arm, thereby allowing the arm to then retract from the load lock 300. The lift pins 308 may also help to remove the electrostatic charge from the wafer 302 during this operation. However, small contact points, the high resistivity of back side of the wafer 302, and the short duration of this operation limit the amount of charge that can be drained through the lift pins 308.

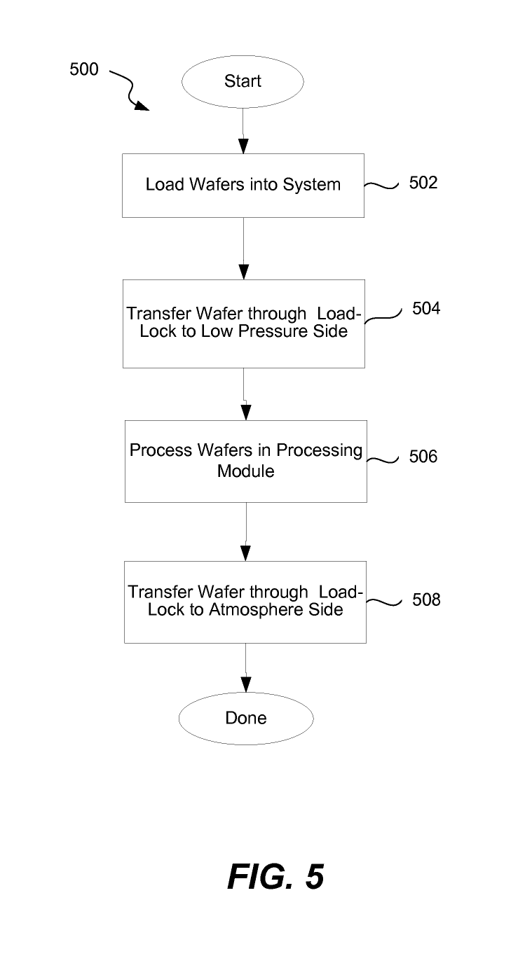

FIG. 4 is a schematic cross-sectional representation of the load lock system 400, in accordance with certain embodiments. The load lock system 400 includes a load lock chamber 402 that encloses a wafer support 406 for holding a wafer 404. The load lock chamber 402 is sometimes referred to as a load lock. As was indicated above, the wafer support 406 may include a cooling plate, support cones, pins, and other elements. Also, it should be readily understood that the wafer 404 may not be present in the load lock chamber 402 at all times. The load lock chamber 402 may have a volume of between about 10 L to 200 L. In a specific embodiment, the load lock chamber 402 has a volume of between about 20 L and 30 L.

The load lock chamber 402 may have a plurality of gas supply and vacuum lines attached to it. The lines may be attached to the bottom or side walls of the load lock chamber 402. These lines may have internal nozzles, distribution devices, and/or shower heads extending inside the load lock chamber 402. In one embodiment, the load lock system 400 may have a venting gas line, a purging gas line, an ionized gas line, and a vacuum line attached to the load lock chamber 402. It may be readily understood that the supply of some of these gases and other functions may be performed by one of the lines. Furthermore, two or more lines may share some components, such as filters, valves, and the like. In a basic piping diagram, the venting gas line may include a venting line inlet 418, a venting line filter 416, and a venting line mass flow meter 414. This line may also include a venting line valve 412 and a venting line delivery port 410 that may be attached to the load lock chamber 402. Furthermore, the line may have a distribution device for delivering the venting gas from the line inside the load lock chamber 402. The venting line inlet 418 is connected to a venting gas supply, which could be a common facility supply or a designated pressurized tank. The venting gas may be helium, air, nitrogen, argon, or a mixture of thereof. The flow rate of the venting gas may be such that the load lock chamber 402 reaches the atmospheric pressure from a certain predetermined initial low pressure in between about 5 to 15 seconds. For example, a load lock chamber that has an internal volume of approximately 25 L may be vented from approximately 5 mTorr to approximately 760 Torr in about 8 seconds. The turbulence in the load lock may be increased during the venting cycle by uneven distribution of the venting gas and using bursts or sub-cycles with varying flow rates. These approaches may also be applicable to the purging gas line and the ionized gas line and other operations.

The purging gas line may include a purging line inlet 428, a venting line filter 426, and a purging line mass flow meter 424. The purging gas line may also include a purging line valve 422 and a purging line delivery port 420 that may be attached to the load lock chamber 402. Furthermore, this line may also include a distribution device for the venting gas inside the load lock chamber 402. The purging gas may be argon, air, nitrogen, or a mixture of thereof. The flow rate of the purging gas may be between about 15-40 slm (standard liters per minute) for a typical 27 L load lock. It should be readily understood that the flow rates may vary with the size of the load lock. The purging gas is supplied when the load lock chamber 402 is already at the atmospheric pressure. Therefore, to avoid pressurizing the load lock chamber 402 during purging, the atmospheric port 408 is opened, allowing the purging gas and any other gases used during purging to escape the load lock 442.

The ionized gas line may include an ionized line inlet 438, an ionized line filter 436, an ionized line mass flow meter 434, an ionizer 433, an ionized line valve 432, and an ionized line delivery port 430 that is attached to the load lock chamber 402 and includes a distribution system for venting gas inside the load lock chamber 402. For example, an a ionized line delivery port 430 may include a shower head positioned on the side of the wafer such that the ionized gas is distributed over both the front and back sides of the wafer 404. A variety of ionizers can be used in the ionized gas line, such as SMC IZN10-1107-82, SMC IZN10-11P07, and MKS inline model 4210un. The gas supplied into the ionized gas line may be air, nitrogen, argon, helium, or a mixture of thereof. The effectiveness of the ionizer 433 may depend on the pressure of the gas inside the ionizer 433; therefore, it may be preferable to position the ionizer 433 before the valve 432 leading to the load lock chamber 402. Moreover, to prevent discharging (i.e., losing charge) of the ionized gas before it flows over the wafer surface, it may be preferable to insulate the internal surfaces of the ionized line delivery port 430 between the ionizer 433 and the wafer 404. For example, the surface may be coated with insulating materials, such as polymers, ceramics, or even anodized metals.

### Processing Examples

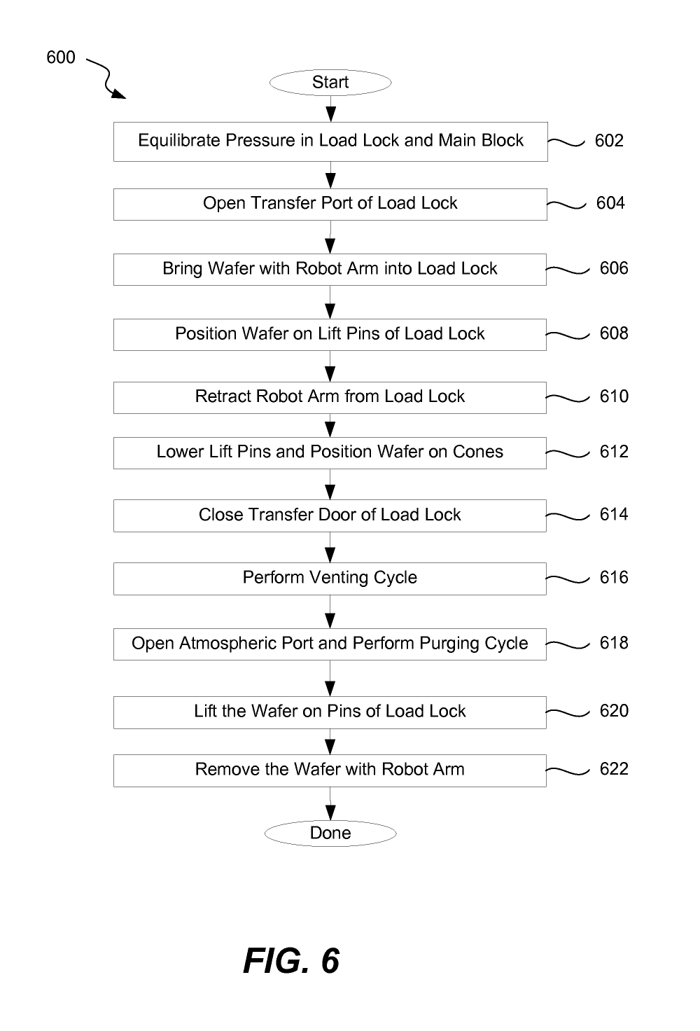

FIG. 5 is a flowchart of a process 500 including various wafer handling operations, in accordance with certain embodiments. The process 500 may start with a wafer being loaded into an atmospheric side during operation 502. The wafer may be provided in a FOUP or any other type of wafer-storing module. The wafer then passes through the load lock and into the low pressure side during operation 504. Depending on the load lock design, multiple wafers may be transferred simultaneously through the load lock. Moreover, the operations for transferring into the low pressure side and for transferring out of the low pressure side may be performed simultaneously. These variations depend primarily on the design of the load lock and processing requirements. Transferring into the low pressure side 504 typically includes transferring a wafer into the load lock using an external wafer handling system, closing the atmospheric port, and pumping the air out of the load lock until the pressure reaches or drops below the pressure level on the low pressure side of the processing system. The load lock is usually vacuumed down to a pressure level of between about 0.01 mTorr and 10 mTorr. It could take around 6-10 seconds to vacuum the load lock down to about 1 Torr and about 10-40 seconds to vacuum it down to about 0.1 Torr. The transfer port is then opened, and the wafer is removed from the load lock through the transfer port.

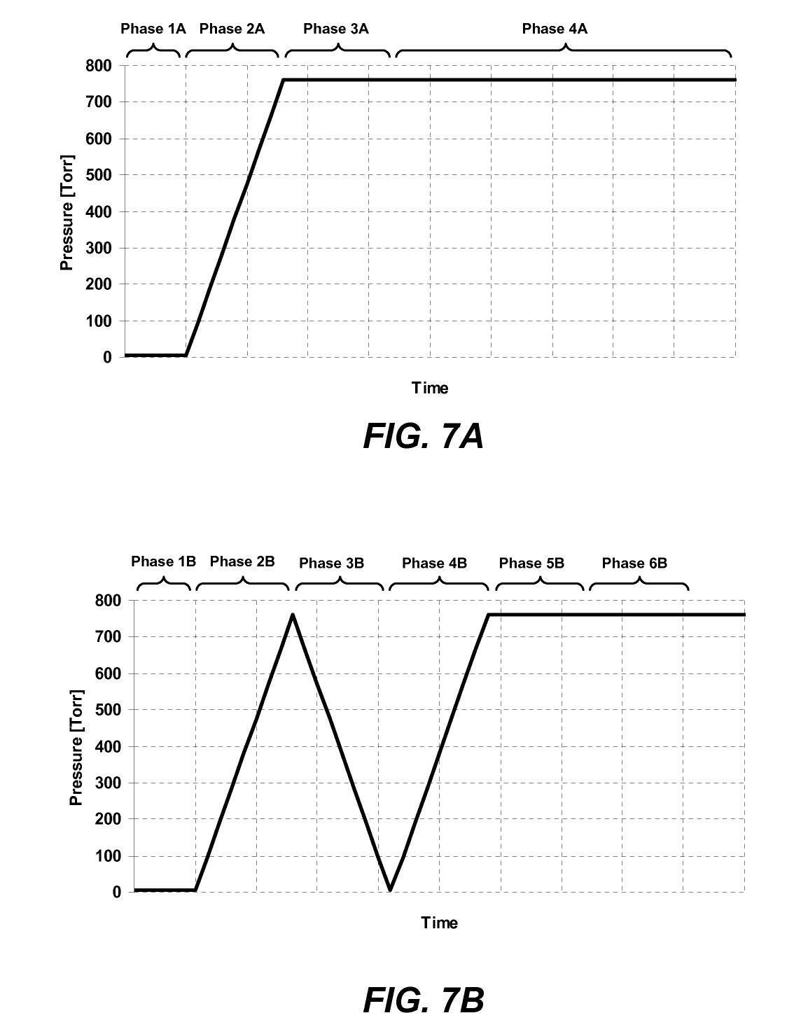

The wafer may be then processed in one or more of the processing modules during operation 506. For example, the wafer may be transferred into one PVD module for barrier film deposition and then into another PVD module for seed layer deposition. During processing and handling in the low pressure side, wafers tend to accumulate substantial electrostatic charge. Moreover, many particles are generated during operation 506 and may be electrostatically and gravitationally attached to the front and back sides of the wafers. The wafer is then transferred through the load lock from the low pressure side to the atmospheric side during operation 508. This last operation 508 is further described below with reference to FIG. 6.

The process 600 may involve various operations for cleaning a substrate wafer while transferring this substrate from a low pressure environment (e.g., near vacuum environment having one of the pressure levels listed above) to an atmospheric environment using a load lock. This process 600 may start with equalizing the pressure between the load lock and the low pressure side as shown in operation 602. Depending on whether the last transfer through this load lock has occurred from the low pressure side or from the atmospheric pressure side, the load lock may be in one of two states (i.e., at a pressure of the low pressure side or at a pressure of an atmospheric side). In certain embodiments, this pressure level is close to the pressure of the side to which the last transfer has occurred. The equalization operation may, therefore, include either pumping or venting of the load lock.

The process 600 may proceed with opening the transfer port during operation 604. A transfer port is a sealed door between the load lock and the low pressure side of the processing system and is sufficiently large for a wafer to pass through while carried by a robot arm of the internal web handling module. The robot arm then carries the wafer into the load lock and positions it above the supporting cones, as shown in operation 606. The supporting cones are typically not long enough to support the wafer high enough above the cooling plate so that the robot arm can move in between the wafer and the cooling plate. Therefore, the wafer may be first positioned on the lift pins, as shown in operation 608. In one embodiment, the lift pins are raised, such that the wafer is lifted from the robot arm by the lift pins during this operation. In another embodiment, the robot arm lowers the wafer onto the tips of the lift pins. The robot arm is then retracted from the load lock during operation 610, and the transfer port is closed during operation 614, thereby sealing the load lock from the low pressure side of the processing system. It can be readily understood that the closing of the transfer port can occur at any point between retracting the robot arm from the load lock and introducing ionized and/or pressurized gases into the load lock. In some embodiments, the lift pins are lowered, and the wafer is rested on the support cones, as shown at operation 612. The support cones establish electrical contact with the wafer, thereby allowing some of the accumulated electrostatic charge to drain thought the cones. Moreover, the design of the cones may be used to align the wafer relative to other parts of the system (more specifically: relative to the robot arms of the external and internal wafer handling modules).

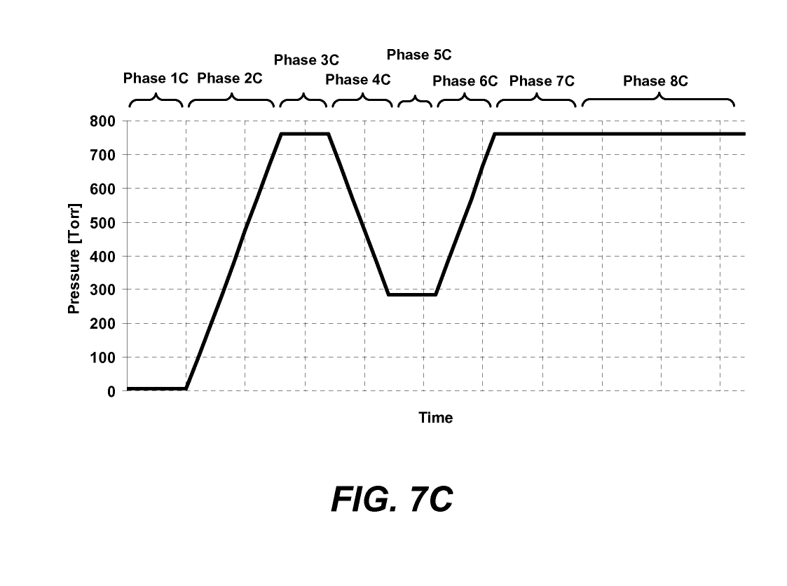

Once the wafer is positioned on the cones, the venting cycle is initiated during operation 616. The venting cycle may involve introducing venting and/or ionized gases into the load lock to increase the pressure in the load lock. The venting cycle may also involve vacuuming gases out of the load lock through the vacuum line. Overall, the load lock is brought from its initial pressure (of the low pressure side) to the final pressure (of the atmospheric side). The venting cycle may include various phases/sub-cycles including pumping, venting, and holding uniform pressure at certain levels. The details of the venting cycle are further explained in the context of FIGS. 7A-C.

Upon completion of the venting cycle during operation 616, the atmospheric port of the load lock may be opened and the purging cycle performed during operation 618. The purging cycle is typically performed with an open atmospheric port and at a uniform pressure; however, it is also contemplated that the atmospheric port may be closed during some period of the purging cycle, and the pressure may deviate from the ambient pressure level. For example, the load lock may be slightly pressurized to facilitate discharge with a higher concentration of ionized gas and to cause additional turbulence for particle removal. During the purging cycle, both purging and ionized gas may flow through the load lock. In one embodiment, both purging and ionized gas flow through the entire purging cycle. Alternatively, the purging cycles may be divided into several sub-cycles, where one of the gases may be turned off. Additional details of the venting cycle are further explained in the context of FIGS. 7A-C.

The wafer may be then lifted from the support cones by the lift pins during operation 620. In one embodiment, the purging cycle is completed at this point and gases are no longer flown through the load lock. In an alternative embodiment, purging and/or ionized gases continue to flow through the whole or parts of operations 620 and 622. Raising the wafer on the lift pins provides a sufficient gap between the cooling plate and the wafer for the robot arm of the external wafer handling system to come in between, raise the wafer from the lift pins, and remove the wafer from the load lock during operation 622. Some of the operations presented in FIG. 6 are optional, which may depend on specific configurations of the equipment used in these operations.

FIGS. 7A-C are plots of pressure levels inside the load lock as a function of time during venting and purging cycles, in accordance with certain embodiments. These illustrations are provided to facilitate better understanding of a cleaning method and are not limiting. In general, a venting cycle may include several phases (or sub-cycles) during which pressure inside the load lock is either increased (venting phases), decreased (pumping phases), or held the same (holding phases). The pressure levels at the end of each phase may be between the low pressure of the low pressure side and the high pressure of the high pressure side (e.g., the ambient pressure of the atmospheric side). However, the pressures may also be below and above this range and are usually only limited by the equipment design.

FIG. 7A illustrates one example of combining venting and purging cycles. In Phase 1A, the wafer is introduced into the load lock, and the transfer port is closed. The pressure during Phase 1A is substantially the same as the pressure in the low pressure side of the processing system and is relatively constant. The transfer port is then closed, and the load lock is vented. Phase 2A represents the entire venting cycle. Venting and/or ionized gases are introduced into the load lock during this phase. In certain embodiments, only venting gas is introduced in this phase. In other embodiments, only ionized gas is introduced in this phase. In yet other embodiments, both venting and ionized gases may be introduced during the entire phase either simultaneously, in sequence, or according to various combinations of these two schemes. The gases may also be introduced and shut at anytime during the phase. For example, Phase 2A may start with an introduction of only the venting gas until the load lock is brought to the first pressure level. At this point, the ionized gas is also introduced into the load lock together with the venting gas. The first pressure level may be between about 0.01 Torr and 760 Torr. In one specific embodiment, the first pressure level is between about 1 Torr and 50 Torr. In another specific embodiment, the first pressure level is between about 100 Torr and 700 Torr. The duration of the venting cycles in accordance with this embodiment may be between 1 and 30 seconds. Moreover, the venting gas may be turned off upon reaching the first pressure level and only ionized gas may be used to complete Phase 2A. It should be readily understood that the order of introducing the ionized gas and the venting gas may also be reversed.

Upon completion of the venting cycle, the pressure inside the load lock is approximately the same as the atmospheric pressure. At this point the purging phase (Phase 3A) is initiated. The atmospheric port is opened and one or both of the purge and ionized gases are introduced into the load lock. With an open atmospheric port, the pressure inside the load lock is maintained essentially constant. Only one of the gases may be supplied through the entire purge cycle. Alternatively, both gases may be supplied through the entire cycle. Additionally, one or both of the gases may be introduced or shut off during Phase 3A. For example, the purging may be initiated with the ionized gas only, and the purging gas may be introduced only after a certain time has elapsed. Then both the ionized gas and the purging gas may be supplied until the end of the cycle. Alternatively, the ionized gas may be turned of when the purging gas is introduced. It should be readily understood that the order of introducing the ionized gas and the purging gas may also be reversed. The duration of Phase 3A may be between 5 and 40 seconds. In addition to discharging the wafer during the venting and purging cycles, gas flow may cause some turbulence around the surface of the wafer and may help to mechanically remove the particles from the surface. The gas flow exerts aerodynamic drag forces on the particles remaining on the wafer surface, which may overcome gravitational/frictional and electrostatic forces, and “blow” the particles from the surface of the wafer.

The gases may be then shut off and the wafer removed from the load lock through the transfer port in Phase 4A. In an alternative embodiment, the gases continue to be supplied until the wafer is completely removed from the load lock.

FIG. 7B illustrates a combination of venting and purging cycles where the venting cycles include an intermediate pumping phase. The wafer loading phase (Phase 1B) and the initial venting phase (Phase 2B) may the same as the respective Phases 1A and 2A and include all illustrative embodiments described therein. However, the pressure in the load lock at the end of Phase 2B does not have to reach the atmospheric side pressure and may be any pressure between about the low pressure and atmospheric pressure or any pressure above or below this range, depending on the equipment capabilities. In one specific embodiment, the pressure level at the end of Phase 2B is between about 100 and 760 Torr. The duration of Phase 2B may be between about 2 and 20 seconds. Next, Phase 3B includes pumping the load lock down to some intermediate pressure (i.e., the second pressure level). The second pressure level may be between about 0.01 Torr and 760 Torr. In one specific embodiment, the second pressure level is between about 1 Torr and 50 Torr. In another specific embodiment, the second pressure level is between about 100 Torr and 700 Torr. Then the load lock is vented back to the atmospheric side pressure level in Phase 4B. Phase 4B may include all illustrative embodiments of Phase 2B. For example, one or both of the venting and ionized gases may be used, and the gases may be introduced or shut off at the beginning of the cycle or some other intermediate phase.

The last two phases of illustrated in FIG. 7B are the purging cycle (Phase 5B) and the removal of the wafer from the load lock (Phase 6B), which may be the same as the respective Phase 3A and Phase 4A.

FIG. 7C illustrates another combination of the venting and purging cycles. The venting cycle is shown having venting and pumping phases and intermediate holding phases where the pressure is maintained constant. Loading of the wafer (Phase 1C) and initial venting of the load lock (Phase 2C) may include all illustrative examples described for Phase 1B and Phase 2B, respectively. However, instead of the immediate pumping of the load lock upon reaching an intermediate pressure level, the load lock is held at this pressure for a certain period of time (Phase 3C). The duration of this period may be between about 1 and 10 seconds. At the end of this holding phase (Phase 3C), the load lock is then pumped to yet another intermediate pressure level (i.e., the second pressure level) in Phase 4C. The load lock is then similarly held at this pressure level for a period of time (Phase 5C). The duration of this second period may be also between about 1 and 10 seconds. The load lock is then vented (Phase 6C) to about atmospheric pressure in a way similar to 4B. The last two phases of are a purging cycle (Phase 7C) and the removal of the wafer from the load lock (Phase 8C), which may be the same as the respective Phase 3A and Phase 4A.

### Experimental Results

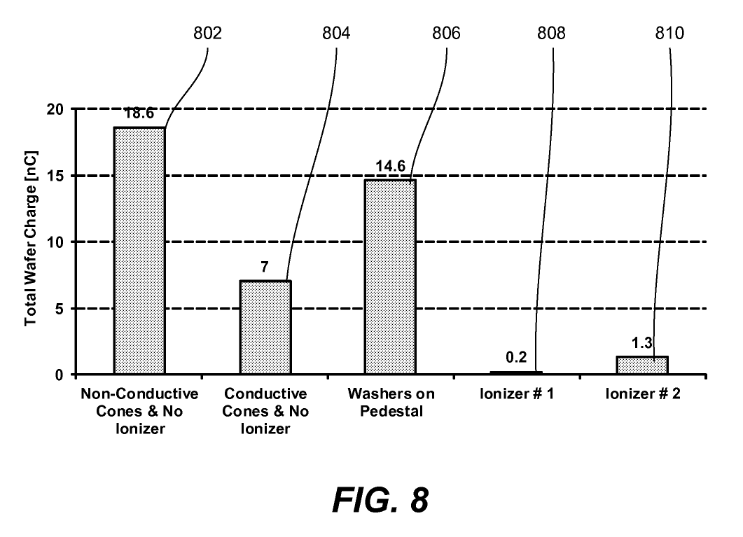

FIG. 8 is a plot of remaining wafer charges after the wafers have been removed from a processing system using a load lock and certain process conditions. The remaining charge was measured soon after the wafer was removed from the load lock. The left-most bar 802 represents a test run where nonconductive cones were used in the load lock to support the wafer. Ionized gas was not using during this test run. The test results indicate that the wafer had a remaining charge of about 18.6 nano-Coulombs. Bar 804 represents a charge of the wafer tested in a load lock that had conductive cones. Adding these conductive supports and effectively removing some charge at least by establishing electrical contact with the back side of the wafer substantially reduced the charge of the wafer to about 7 nano-Coulombs. A benchmark test was conducted with 10 to 20 stainless steel washers positioned randomly on the cooling plates (i.e., pedestal) to establish electrical connection between the wafer and the plate through such washers. The results of this test are shown with bar 806. The total charge of the wafer relative to the first test was reduced to 14.6 7 nano-Coulombs. This indicates that discharge through the back side of the wafer and stainless steel washers is not as effective as with specially designed conductive cones. These results further supports the understanding that the lift pins do not provide sufficient discharge of the plate during the wafer's loading and unloading. The last two bars 808 and 810 correspond to test runs performed with adding ionized gas into the load lock. Conductive cones were also used in both of these runs. The ionized gas was produced using different types of ionizers. However, the charge difference caused by the differences in these ionizers was not significant relative to the overall improvement in these tests (i.e., 0.2 nano-Coulombs remaining charge and 1.3 nano-Coulombs remaining charge). The ionized gas was based on nitrogen, and it was supplied during the entire period. The flow rates of the ionized gas in both tests were about the same as the flow rates of the venting and purging gases in these tests.

Additional tests were conducted to compare the effects of an ionizer and conductive cones on particle contamination, which is based on counting a number of particles measuring 0.2 μm or greater that remain on the substrate after the test. When insulating cones were used and the ionizer was turned off, the average particle count was approximately 10. The process conditions were then changed. An ionizer was used to supply the ionized gas created from nitrogen. The ionized gas was supplied through the side window of the load lock. The window was fit with a stainless steel inlet tube. The wafer was positioned on five conductive Cerastat cones. With these process conditions, the particle count dropped substantially to less than 5 on average. These results indicate significant improvement using an improved cleaning method with ionized gas supplied into the load lock chamber and positioning wafers on conductive cones when transferring wafers from a low pressure side to an atmospheric side of the processing system

### Additional Embodiments

The apparatus/process described hereinabove may be used in conjunction with lithographic patterning tools or processes (for example, for the fabrication or manufacture of semiconductor devices, displays, LEDs, photovoltaic panels and the like). Typically, though not necessarily, such tools/processes will be used or conducted together in a common fabrication facility. Lithographic patterning of a film typically includes some or all of the following steps, with each step enabled with a number of possible tools: (1) application of photoresist on a workpiece (i.e., substrate, using a spin-on or spray-on tool); (2) curing of photoresist using a hot plate or furnace or UV curing tool; (3) exposing the photoresist to visible, UV, or x-ray light with a tool such as a wafer stepper; (4) developing the resist so as to selectively remove resist and thereby pattern it using a tool such as a wet bench; (5) transferring the resist pattern into an underlying film or workpiece by using a dry or plasma-assisted etching tool; and (6) removing the resist using a tool such as an RF or microwave plasma resist stripper.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A method of cleaning a substrate wafer while transferring said substrate wafer from a near vacuum environment of a process module to an atmospheric environment of a storage module using a load lock, the method comprising:
(a) providing the substrate wafer to the load lock;
(b) closing a transfer port of the load lock;
(c) increasing pressure inside the load lock to a first pressure level by supplying a pressurizing gas into the load lock; and
(d) supplying an ionized gas and the pressurizing gas into the load lock while a pressure inside the load lock is below or equal to an ambient pressure of the storage module.

2. The method of cleaning the substrate wafer of claim 1, wherein the pressurizing gas comprises helium.

3. The method of cleaning the substrate wafer of claim 1, wherein the ionized gas comprises ions of nitrogen.

4. The method of cleaning the substrate wafer of claim 1, further comprising opening an atmospheric port of the load lock and supplying the ionized gas and a purging gas into the load lock.

5. The method of cleaning the substrate wafer of claim 4, wherein the purging gas comprises argon.

6. The method of cleaning the substrate wafer of claim 4, wherein a ratio of a flow rate of the purging gas to a flow rate of the ionized gas is between about 0.1 and 10.

7. The method of cleaning the substrate wafer of claim 4, wherein supplying the ionized gas and the purging gas into the load lock continues for between about 1 and 10 seconds.

8. The method of cleaning the substrate wafer of claim 1, wherein a ratio of a flow rate of the pressurizing gas to a flow rate of the ionized gas is between about 0.1 and 10.

9. The method of cleaning the substrate wafer of claim 1, wherein the supplying the ionized gas and the pressurizing gas into the load lock provides an even distribution of the ionized gas and the pressurizing gas over a top surface and a bottom surface of the substrate wafer.

10. The method of cleaning the substrate wafer of claim 1, wherein the first pressure level is between about 0.01 Torr and 760 Torr.

11. The method of cleaning the substrate wafer of claim 1, wherein the first pressure level is between about 1 Torr and 50 Torr.

12. The method of cleaning the substrate wafer of claim 1, wherein the first pressure level is between about 100 Torr and 700 Torr.

13. The method of cleaning the substrate wafer of claim 1, further comprising keeping the pressure inside the load lock at the first pressure level for between about 1 and 10 seconds after increasing the pressure inside the load lock to the first pressure level.

14. The method of cleaning the substrate wafer of claim 1, further comprising reducing the pressure inside the load lock to a second pressure level after previously increasing the pressure to the first pressure level.

15. The method of cleaning the substrate wafer of claim 14, wherein the second pressure level is between about 0.01 Torr and 760 Torr.

16. The method of cleaning the substrate wafer of claim 14, wherein the second pressure level is between about 1 Torr and 50 Torr.

17. The method of cleaning the substrate wafer of claim 14, wherein the second pressure level is between about 100 Torr and 700 Torr.

18. The method of cleaning the substrate wafer of claim 14, further comprising keeping the pressure inside the load lock at the second pressure level for between about 1 to 10 seconds after reducing the pressure inside the load lock to the second pressure level.

19. The method of cleaning the substrate wafer of claim 1, further comprising removing the wafer from the load lock through an atmospheric port; and
wherein the substrate wafer has a total charge of less than about 1 nano-Coulomb at the time of removing.

20. The method of claim 1, wherein the providing the substrate wafer to the load lock further comprises positioning of the substrate wafer on conductive substrate support cones.

21. The method of cleaning the substrate wafer of claim 1, further comprising:
applying photoresist to the substrate wafer;
exposing the photoresist to light;
patterning the photoresist to create a pattern and transferring the pattern to the substrate wafer; and
selectively removing the photoresist from the substrate wafer.

22. A load lock system for cleaning a substrate wafer, the load lock system comprising:
(a) a load lock adapted for integration with a processing chamber via a transfer port;
(b) conductive substrate support cones to support and contact the substrate wafer;
(c) a vacuum line port;
(d) a pressurized gas line port;
(e) a purge gas line port; and
(d) an ionizer system configured to deliver ions through an ionizer line to the substrate wafer positioned inside the load lock.

23. The load lock system of claim 22, further comprising a shower head configured to evenly distribute an ionized gas and a pressurized gas over a top surface and a bottom surface of the substrate wafer.

24. The load lock system of claim 22, wherein the ionizer line comprises non-conductive material in the contact with the ions delivered to the substrate wafer.

25. The load lock system of claim 22, wherein the conductive substrate support cones comprise a conductive ceramic material.

26. The load lock system of claim 22, further comprising a controller comprising program instructions for:
(a) providing the substrate wafer into the load lock;
(b) closing the transfer port of the load lock;
(c) increasing pressure inside the load lock to a first pressure level by supplying a pressurizing gas into the load lock; and
(d) supplying an ionized gas and the pressurized gas into the load lock while a pressure inside the load lock is below an ambient pressure of a storage module.

27. The load lock system of claim 22, further comprising a stepper.
